(19) United States
(12) Patent Application Publication
(10) Pub. No.: US 2003/0034662 A1
(43) Pub. Date: Feb. 20, 2003

(54) Food serving device with integral clamp

(76) Inventor: Waltor Brent Wilson, Jeffersonville, IN (US)

Correspondence Address: WALTOR BRENT WILSON, 1208 SANDSTONE DR., JEFFERSONVILLE, IN, 47130, US

(21) Appl. No.: 10/209,239

(22) Filed: Jul. 31, 2002

Related U.S. Application Data
(60) Provisional application No. 60/310,126, filed on Aug. 3, 2001.

(51) Int. Cl. A47J 43/28

(52) U.S. Cl. 294/7

(57) ABSTRACT

A device which has been designed and tested to improve the ease and cleanliness of transporting food portions from one place to another. The one-handed operation is simple and intuitive. Portions of food may be sliced from an original whole with the slicing edge and the cutting teeth on the spatula. Food portions may also be freed from being stuck to a serving plate or pan when the wedge shaped risers on the bottom of the spatula portion are slid underneath the food portion. A clamp bar operated by a thumb or a forefinger applies clamping pressure to the food portion while it is being transported, preventing the food from falling off of the spatula and eliminating the need for another device or the use of a finger of the server's other hand to insure that the food portion remains on the spatula while being moved. Especially useful for difficult to serve foods such as pizza, where cheese strings remain attached to the piece being removed and pull it from the spatula. Additionally, with pizza, the topping is not always firmly attached to the underlying crust and often will slide off of the crust with even a small amount of tilting away from level. This food serving device eliminates those two problems specifically associated with serving pizza type foods. This food serving device is the quickest and most sanitary means of serving food portions available and clearly advances the state of the art of spatulas as food serving devices.

### CROSS-REFERENCE TO RELATED APPLICATIONS

Not applicable.

### BACKGROUND—FIELD OF INVENTION

This invention relates to the serving of food portions such as pie, cake or pizza slices with a spatula-like device.

### BACKGROUND—DESCRIPTION OF PRIOR ART

An investigation was unable to locate or reveal any commercially available product designed to solve the combined problems of transporting food portions with one-handed operation and improving sanitary food handling with one device.

A patent search did not reveal the existence of any prior art pertaining to the controlled, single-handed sanitary transporting of sliced food portions.

This invention was developed in response to the observed difficulties of removing slices of pie, cake or pizza from the whole pie, cake or pizza for the purpose of moving the food portion to another location. A standard spatula-type server will work, however the sliced food product often will either fall over from its' own height or the food portion simply slides off of the spatula as the spatula is pulled away due to some parts of the food not being completely separated. Observation has revealed that no spatulas commercially available are constructed to solve this problem and are all configured according to a design and form that has been used for centuries in the serving of food. Our device intends to advance the state-of-the-art for spatulas and food serving utensils by creating a device that can, using only one hand, work in those situations where a plain spatula not equipped with an integral clamping bar experiences difficulty. Our device, by being able to remove the food portion without making a mess, or requiring another hand or implement to accomplish the task, is a step forward in the usefulness of the spatula as a food serving device. Note that the terms pie, cake, pizza and food portion are used interchangeably throughout this document in reference to various foods which are cut or sliced from the large original whole item into smaller individual portions. The term “Server” refers to a person who has been designated to transport the individual sliced or cut portions of a food from the original form to individual plates.

In practice, the available devices for removing sliced food products from their original form are limited in variety and scope. The existing devices do not easily allow for the sliced food portion to be removed, or removed in one piece, or to be removed using just one hand or without touching the food every time. The difficulty of getting the sliced food portion removed and ready for serving can be affected by several factors. For example, the food product may not have been cleanly and completely separated from the original portion. This condition causes the food to hang up or tear apart and sometimes results in the food sliding off the spatula. The food portion to be served may be tall, or top heavy, or both, such as cake and naturally wants to fall over sideways once the sides of the cake clear the rest of the cake. Some foods will have toppings that are simply resting on the underlying support crust, such as pizza, that are not firmly attached to the supporting crust. When a spatula attempts to lift the sliced portion clear of the rest of the food, the topping layer will slip off of the underlying support crust. In any of the instances previously cited, the use of a conventional spatula often results in either the server having to place a hand, finger or using another device on the food to prevent the loss of control. Typically, this other device would be another food serving implement such as a fork or a knife. Either way, two hands are now required to do what our food-handling device can easily do with just one hand. In practice, servers often end up touching the food they are serving to others by using a finger and that is not always a sanitary situation. Our food handling device has been designed to specifically resolve all of these issues.

### SUMMARY

The food portion serving device described herein allows the one-handed safe and secure removal of smaller food portions, such as slices of a pie, cake or pizza, from the larger whole food portion and the relocating of said food portions to another location without the need to touch or use another utensil and dramatically diminishes the possibility of dropping the food portion in the process of relocation.

### OBJECTS AND ADVANTAGES

1. This device will present a better way to handle sliced food portions. The operation of this device is completely one-handed.

2. The ability to clamp the sliced food portion to the spatula via a server controlled device prevents food from falling or sliding off of the spatula.

3. The food lifting risers on the bottom of the spatula act as a wedge to apply leverage to lift and free food which is stuck to the serving pan or plate surface as the spatula is slid underneath the food portion.

4. The finger or thumb controlled clamp can be lifted or lowered at will single-handedly by the operator. No real strength is needed.

5. Sanitation issues related to the unnecessary handling or touching of the food by the server are virtually eliminated.

6. Sanitation issues and/or wastage of food portions issues that arise when food in the process of being served falls off the spatula onto the floor or some other undesired place are addressed by minimizing the possibility of these events

7. This device is neither right nor left handed in operation and its use by either left or right handed persons is not limited or enhanced in any way by those individual characteristics.

8. The amount of time required to serve multiple portions of food is reduced by the secure and controlled clamping of the food portion to the device.

### DRAWING FIGURES

FIG. 1 is a perspective view from the spatula end looking toward the handle end.

FIG. 2 is a side view showing the action of the food being served (in this example-pizza) as the spatula end is slid underneath and toward the center of the pizza.

FIG. 3 is a side view showing the top clamp being raised by the server's thumb to clear the crust on a piece of pizza.

FIG. 4 is a side view showing the clamp lowered by the server's thumb to clamp the food to the spatula.

### REFERENCE NUMERALS IN DRAWINGS

12 food clamp 28 food cutting teeth

14 spatula 30 finger grip reliefs

16 handle 34 hinge joint

18 clamp bar tab 36 food portion

20 clamp bar 38 slicing edge

22 clamp bar pad 40 server's thumb

24 food lifting risers 42 server's hand and fingers

26 hanging hook 44 serving pan or plate surface

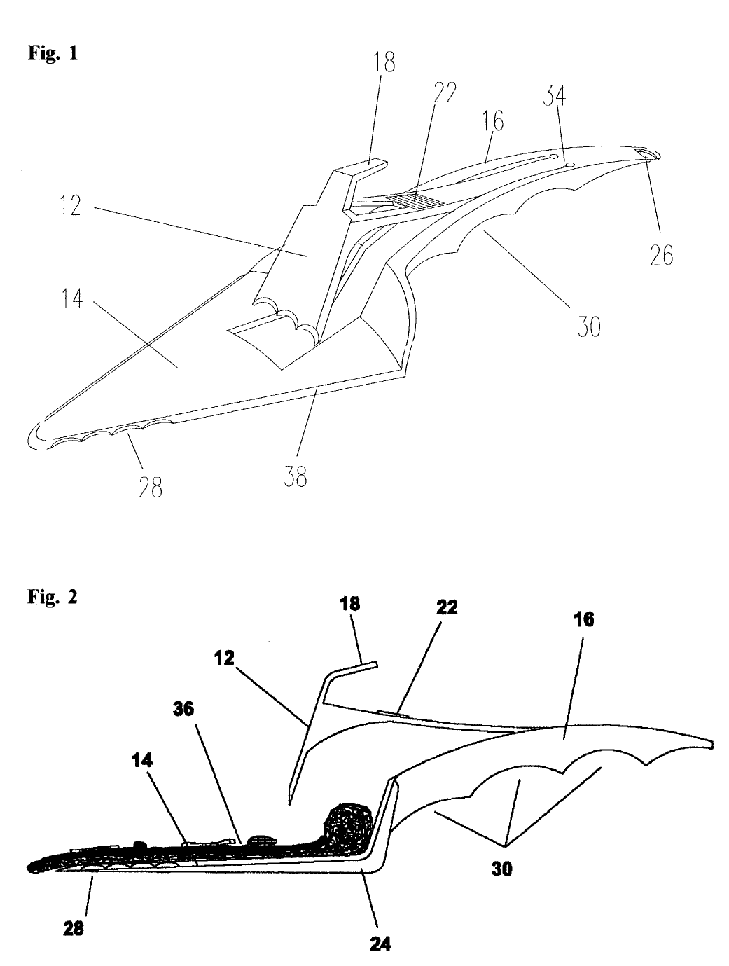

### DESCRIPTION—FIGS. 1, 2, 3 AND 4—PREFERRED EMBODIMENTS

FIG. 1 is a perspective view of the food handling device. Item 12 is the food clamp. Item 14 is the spatula portion of the device. The spatula portion slides under food portions to be served and supports them while being transported from the plate or pan to another location. Item 16 is the handle which may be grasped in either the left or the right hand. Item 18 is the tab on the top part of the clamp bar which is used by applying upward pressure with a finger or a thumb to raise the clamp as needed. Item 20 is the clamp bar. Item 22 is the pad area of the clamp bar, where downward pressure applied by a thumb or finger clamps the food being served to the spatula. Item 34 is the hinge joint which allows for the upward and downward travel of the food clamp

FIG. 2 is a side view of the food serving device shown as it is being slid from right to left underneath a food portion 36 resting on a serving pan or plate surface 44. As the spatula 14 slides towards the left, the food lifting risers 24 located on the bottom of the spatula 14 begin to apply upward pressure on the food portion 36 causing it to lift free of the serving pan or plate surface 44. This feature is useful when the food portion to be served is stuck to the serving plate or pan.

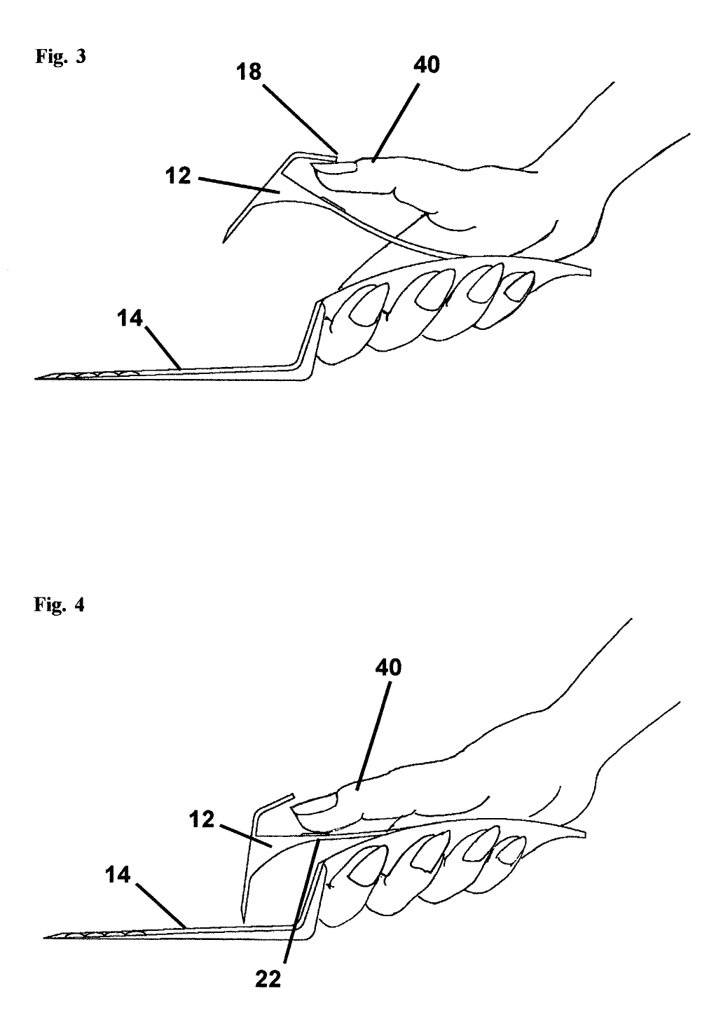

FIG. 3 is a side view of the food serving device showing the effect of applying upward pressure via the server's thumb or finger 40 on the clamp bar tab 18 causing the food clamp 12 to rise higher than its' at-rest location. This feature is useful when serving tall items.

FIG. 4 is a side view of the food serving device showing the clamp bar 20 being depressed downward by the server's thumb 40 on the clamp bar pad 22 to impress the food clamp 12 into the food and therefore to the spatula 14. This feature is useful when serving food items that are less than 25 millimeters thick.

### OPERATION—FIGS. 1, 2, 3 and 4

In operation, the food handling device allows for the single-handed and sanitary transporting of food portions from the central serving plate to other plates.

The handle 16 is grasped by the server in either the left of the right hand 42. Depending on the method of grip, the server may utilize fully or partially the finger grip reliefs 30 styled into the bottom of the handle 16. The server, at his or her preference, may then place a forefinger or a thumb on the pad 22 located on the clamp bar 20. This locates the finger or thumb directly below the tab 18.

The server may elect to slice the food with the slicing edge 38 of the spatula if the food has not been already sliced. If the slicing was incomplete, then the cutting teeth 28 on the slicing edge at the front of the spatula may be employed to further separate the food portion from the original whole.

Once satisfied that the portion to be served is free on its' sides from the rest of the original whole food product, the server then proceeds to slide the spatula 12 portion of the food handling device underneath the food portion 36 to be separated from the original whole. If the food portion is stuck to the serving pan or plate surface 44, then the food lifting risers 24 will begin to lift the food as the spatula portion moves inwards. This lifting and un-sticking action is caused by the tapered wedge action of the food lifting risers 24 affixed to the bottom side of the spatula 14.

If the food portion to be served is to tall to fit under the food clamp when it is in its' at rest position, the server may elect to apply upward pressure on the clamp bar tab 18 with a thumb or finger 40 to raise the food clamp 12 sufficiently to clear the top of the food portion, while sliding the spatula 14 into place underneath the food portion 36.

With the spatula 14 in place directly under the food portion 36 to be served, the server then applies downward clamping pressure as needed via the thumb or forefinger 40 on the clamp bar pad 22 to secure the food portion 36 to the spatula 14. The server may judge by observing the behavior of the food portion just how much pressure to apply.

The server is now ready to remove the food portion 36 from the original serving plate 44 to another location.

The server then deposits the food portion 36 at the desired new location by simply applying upward pressure on the clamp bar tab 18 sufficient to release the food portion 36 from the food clamp 12. Tilting the spatula 14 forwards to allow the food portion to slide off of the spatula 14 may sometime be needed to clear the food portion 36 from the spatula 14.

### CONCLUSION, RAMIFICATIONS, AND SCOPE

Accordingly, the reader will see that the usefulness of this device is obvious to anyone who has had the experience of having food topple off of a conventional spatula or experienced the frustration of trying to remove a slice of pizza when strings of melted cheese keep trying to hold the pizza slice in place. The simple addition of a thumb or finger actuated clamping device to the spatula creates an entire new class of food serving utensils.

The integration of a cutting edge onto the spatula, while not in and of itself unique, combined with the clamping bar effectively obsoletes the use of ordinary non-clamping spatulas.

Dramatically minimizing the possibility of food portions being dropped because of the increased control of the food portion will allow the operator to serve more food portions in less time, while reducing the amount of food wastage that results from dropped portions.

I claim:

1. In a food handling spatula device a means for clamping food portions intended to be transported from one place to another using only one hand and to minimize unnecessary handling while improving the sanitary handling of food portions.

2. The food clamping action of claim 1 whereby the body of said device is molded from plastic and comprises only one contiguous piece of plastic when molded.

3. The food clamping action of claim 1 whereby the body of said device is molded from more than one piece of plastic and the said clamp arm being molded and attached separately.

4. The food clamping action of claim 1 whereby the body of said device is made from metal and is stamped in one piece and bent so as to provide the handle, clamp arm, spatula and food lifting risers in one piece of metal.

5. The food clamping action of claim 1 whereby the body of said device is made from metal with a separate clamp arm which is made and attached separately

6. In a food handling spatula device a means for applying clamping pressure to different heights and thicknesses of food portions so that they will not slide or fall from the transporting device.

7. The clamping means of claim 6 being operated by the thumb and being able to traverse vertically upwards to clear taller food portions and downwards to apply clamping pressure to the food portion.

8. The clamping means of claim 6 being operated by the server's finger and a mechanism integral to said device which provides both a means to raise and lower the food clamping arm for the purpose of clearing taller food portions and bringing clamping pressure to bear on the food portion.

9. The clamping means of claim 6 being operated by a squeezing or gripping action of the server's hand and a mechanism integral to said device which provides both a means to raise and lower the food clamping arm for the pur pose of clearing taller food portions and bringing clamping pressure to bear on the food portion.

10. A means in a food handling spatula device of simultaneously lifting and freeing stuck food from a serving plate while preparing it for removal to another location.

11. The lifting means in claim 10 whereby the lifting and freeing action of a food handling spatula device occurs when said device is equipped with wedge shaped food lifting risers located on the bottom side of the spatula are positioned with the small ends of the food lifting risers under the stuck food portion and the entire food handling spatula device is moved inwards so as to force the food portion to raise and become un-stuck as the progressively taller ends of the food lifting risers are forced under the food portion.

12. The lifting means in claim 10 whereby the lifting and freeing action of a food handling spatula device occurs when said device is equipped with a lifting mechanism integral with the spatula that applies pressure between the bottom of the food portion and the surface to which it is stuck so as to free said food portion from being stuck and allowing the food handling spatula device to move into position under the food portion to be removed.
